(19) United States
(12) Patent Application Publication
(10) Pub. No.: US 2002/0135566 A1
(43) Pub. Date: Sep. 26, 2002

(54) Apparatus, method, and system for change of display direction

(75) Inventor: Jang-Li Chang, Taipei (TW)

Correspondence Address: GREENBLUM & BERNSTEIN, P.L.C., 1941 ROLAND CLARKE PLACE, RESTON, VA, 20191, US

(73) Assignee: SILTEK CORPORATION, Taipei (TW)

(21) Appl. No.: 09/900,195

(22) Filed: Jul. 9, 2001

(30) Foreign Application Priority Data
Mar. 21, 2001 (TW) 090106656

(51) Int. Cl. G09G 5/00

(52) U.S. Cl. 345/169

(57) ABSTRACT

The invention discloses an apparatus, method and system to change display direction. As the size of electronic devices, e.g. PDAs, become smaller and smaller, peripherals thereof, e.g. keyboards, take separable form to flexibly downsize the electronic devices. Compared to a first display direction as separable peripherals are connected to electronic devices, a second display direction as separable peripherals are not connected is capable to provide more convenience to users. The connecting apparatus of electronic devices accept separable peripherals connections and status thereof. If electronic devices detect the existence of separable peripherals, the first display direction is used to display data on display devices, else the display devices present data in the second direction.

### FIELD OF THE INVENTION

The present invention relates to an apparatus, method, and system for displaying data, and more particularly, relates to an apparatus, method, and system for displaying data with variable display directions.

### BACKGROUND OF THE INVENTION

As rapid development of nowadays-electronic technology, more and more electronic devices are equipped with display devices. These display devices have various types, and two examples of the display devices are Cathode Ray Tube(CRT) and Liquid Crystal Display(LCD). These display devices are not only applied in computers but also applied in sorts of electronic devices to provide the status of the electronic devices to users or for the interaction purpose.

With the advancement of technology, the design of electronic devices keeps downsizing. Many examples can be found in our lives, like mobile phones, personal digital assistants (PDAs), translators, notebook computers, and recorders, etc. Small size of design facilitates users to carry such electronic devices. However, when performing input or output to the electronic devices, inconvenience for users occurs unfortunately.

First, as concerning the part of input operation, though it is possible to shrink the size of input devices in technical aspect, the size of human fingers brings up the limitation. Several alternative devices are therefore created, like stylus, mouse, and panel. However, problems still exist.

Second, as concerning the part of output operation, it is very critical to provide an efficient and effective display as the size of display is under some level. It is found that even the size remains unchanged, adjusting the display direction brings a significant effect. The demand of display direction variance may not yet become an issue in desktop computer displays, but for various electronic devices with sorts of functions, it is attractive to provide capability of flexible display directions.

In addition, as concerning the input operations, a solution is suggested that input devices may be separable from the electronic devices. In other words, input devices become separable peripherals. For example, for those products such as mobile phones or PDAs, external keyboards or other peripherals are more and more popular. However, if we can adjust display direction according to the existence of such peripherals, more advantages will be obtained.

Nevertheless, the present electronic devices either lack flexible display directions or need a manual operation to switch the display directions. These bring complexity for users.

### SUMMARY OF THE INVENTION

Therefore, the invention discloses an apparatus, method and system for changing display direction automatically. One embodiment of the present invention includes a display device, a connecting device, and a processing device. The status of the connecting device is presented. As the peripheral device, e.g. a keyboard, is connected to the connecting device, the status is set as a first status. As the peripheral device is not connected to the connecting device, the status is set as a second status. If the status detected by the processing device is the first status, a first direction is used to display data on the display device. If the status detected by the processing device is the second status, a second direction is used to display data on the display device.

A preferred embodiment of the present invention is applied in PDAs, wherein the connecting device is a Universal Serial Bus (USB). As a peripheral device, such as a keyboard, is connected to the USB interface, the USB interface presents the existence of the peripheral device. The PDA detects the status of existence of the external keyboard, and the data is then displayed in the horizontal direction. If the USB interface presents that no external keyboard is connected to the USB interface, PDA displays data on its screen in the vertical direction.

### BRIEF DESCRIPTION OF THE DRAWINGS

FIG. 1 illustrates the architecture diagram of one embodiment of the present invention;

FIG. 2 illustrates a flow chart of the embodiment of the present invention;

FIG. 3 illustrates a architecture diagram of one exemplary embodiment;

FIG. 4A illustrates one status of the exemplary embodiment; and

FIG. 4B illustrates another status of the exemplary embodiment.

### DETAILED DESCRIPTION OF THE INVENTION

The present invention may be described herein in terms of functional block components, screen shots, optional selections, and various processing steps. It should be appreciated that such functional blocks may be realized by any number of hardware and/or software components configured to perform the specified functions. For example, the present invention may employ various integrated circuit components, e.g. memory elements, processing elements, logic elements, look-up tables, and the like, which may carry out a variety of functions under the control of one or more microprocessors or other control devices. Similarly, the software elements may be implemented with any programming or scripting language such as C, C++, Java, COBOL, assembler, PERL, or the like, with the various algorithms being implemented with any combinations of data structures, objects, processes, routines or other programming elements. Further, it should be noted that the present invention may employ any number of conventional techniques for data transmission, signaling, data processing, network control, and the like.

It should be appreciated that the particular implementations shown and described herein are illustrative to the invention and its best mode and are not intended to otherwise limit the scope of the present invention in any way. Indeed, for the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationship and/or physical couplings between the various elements.

It should be noted that the embodiment coupled within a PDA with related drawings described herein are not intended as limitations of the invention.

It should be also noted that many applications of the present invention could be formulated. One skilled in the art will appreciate that all kinds of input apparatus, like keyboard, mouse, stylus, and/or the like, are allowed for users to use to interact with the system of the invention. Similarly, it is feasible to couple the invention within various computers, PDAs, handheld computers, notebook computers, mobile phones, digital cameras, and/or the like. These electronic devices may be loaded with various operating systems, like Windows of all versions, Palm OS, MacOS, OS/2, BeOS, Linux, and/or the like.

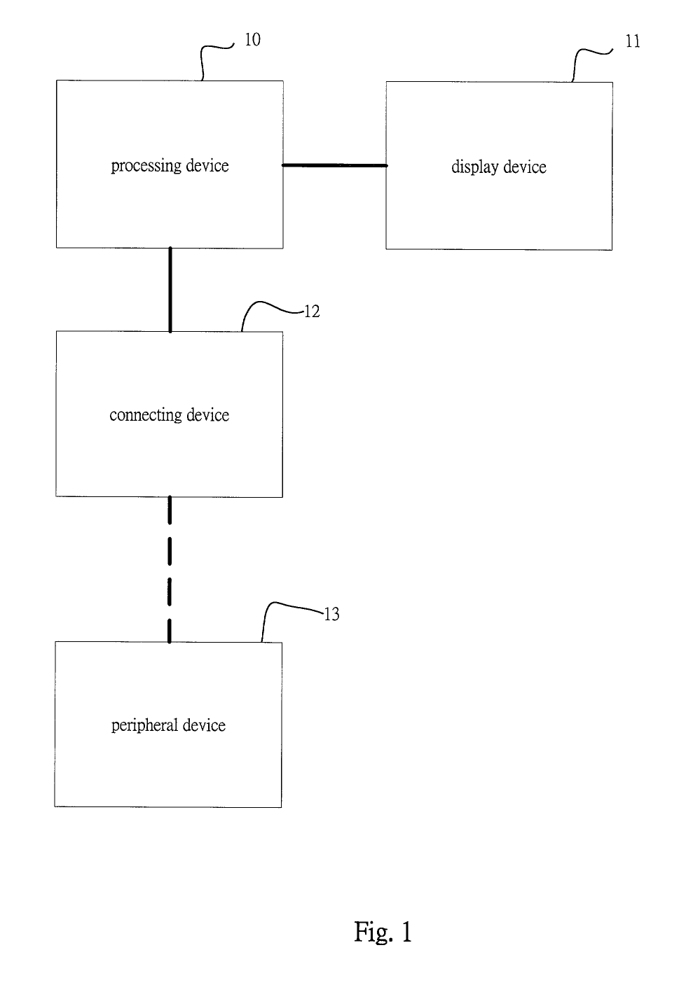

As illustrated in FIG. 1, in an exemplary embodiment, the system of the present invention comprises a processing device 10, a display device 11, and a connecting device 12. The processing device 10 is electrically connected to the display device 11 and the connecting device 12. The connecting device 12 provides connection to the peripheral device 13. The connection of the connecting device 12 and the peripheral device 13 may be wired or wireless.

For example, in one embodiment of PDA, processing device 10 includes hardware, i.e. processors, memory, and bus, etc. and software, i.e. driving programs, operation systems, and application programs, etc. In addition, display device 11 is an LCD in one of the embodiment. The connecting device 12 includes an interface of PCMCIA and an interface of USB. A peripheral device 13 may be a keyboard, a stylus, and any other indicator and the like. A peripheral device 13 may also include any possible peripheral device which is allowed to be connected to the connecting device 12.

The processing device 10 displays the data on the display device 11 in different directions. For example, the data may be displayed in a horizontal direction or in a vertical direction. There is certain software and hardware to display the data on the display device 11 in different directions. Software, for example, can change the coding of the driving program, the operation system, or the application program so that the output data is switched to a different display direction. Hardware, on the other hand, can change the memory of the coordinates to achieve the same result. People skilled in the art should know the above-mentioned technology.

When a peripheral device 13, such as an input device including a keyboard, a stylus, a mouse, a panel, and the like or other peripheral devices including a disk drive and a digital camera, etc., is connected to the connecting device 12, the status of the connecting device 12 is changed. One of the embodiments of the connecting device 12 is an interface of the USB. When a peripheral device 13 is connected to the USB, the connecting status of the peripheral device 13 is recorded. The processing device 10 then detects the connecting status by hardware or software. When the detected status is the first status, processing device 10 displays the data on the display device 11 in the first direction. For the illustrative purpose, the first status is the status when the peripheral device 13 is connected, and the second status is the status when the peripheral device 13 is not connected. When the connecting status is detected as the second status, processing device 10 displays the data on the display device in the second direction. The first direction in one of the embodiments is a horizontal direction, and the second direction is a vertical direction. Thus, the apparatus is more user-friendly.

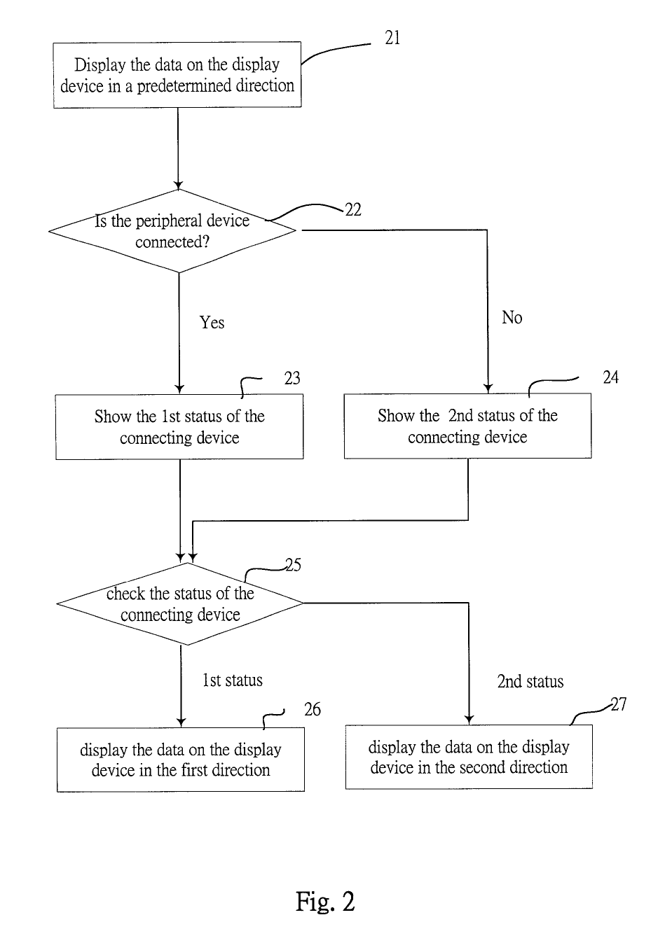

Please now refer to FIG. 2. FIG. 2 illustrates the present invention in a flow chart. First, the processing device 10 displays the data on the display device 11 in a predetermined direction (step 21). The processing device 10 then detects whether the peripheral device 12 is connected (step 22). If the peripheral device 13 is connected to the connecting device 12, the status of the connecting device 12 is shown as the first status (step 23); if the peripheral device 13 is not connected to the connecting device 12, the status of the connecting device 12 is shown as the second status (step 24). The processing device 10 then checks the status of the connecting device 12 (step 25). If the status is the first status, the processing device 10 displays the data on the display device 11 in the first direction (step 26). If the status is the second status, the processing device 10 displays the data on the display device 11 in the second direction (step 27).

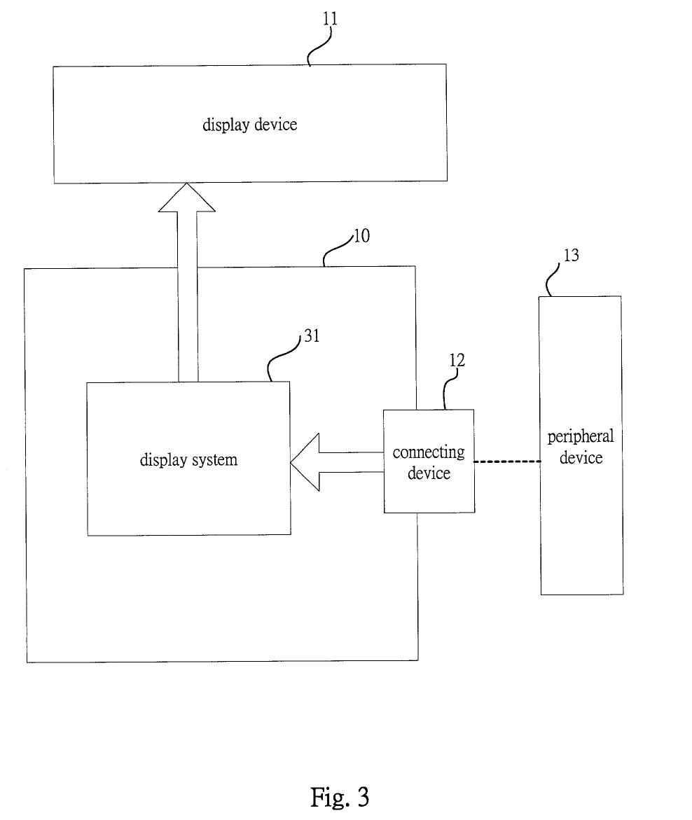

Please refer to FIG. 3, which illustrates the present invention according to another embodiment. The electronic apparatus nowadays usually provides an image output module. The image output module as a display system includes an output interface to display the data on the display device. In a Window operation system, for example, different GUI interfaces are provided to other application programs to output the data to the display device. The image output module can be combined with the operation system, exist in the form of the driving program, or be recorded as a hardware device. One of the embodiments of the image output module includes the image output module adopted in a PDA.

According to FIG. 3, the processing device 10 includes a display system 31. The display system 31 checks with the connecting device 12 to determine whether the peripheral device 13 is connected or not. When the display system 31 detects the existing of the peripheral device 13, the display system 31 then processes and displays the data in the first direction. On the other hand, the display system 31 processes and displays the data in the second direction when the display system 31 does not detect the existing of the peripheral device 13. The embodiment of the connecting device 12 may check the existing status of the peripheral device 13 by the interface of the USB. When the peripheral device 13 is connected, the interface of the USB transmits a value of the status. The display system 31 then determines whether the peripheral device 13 exists by this value. The display direction of the data is further determined according to the result.

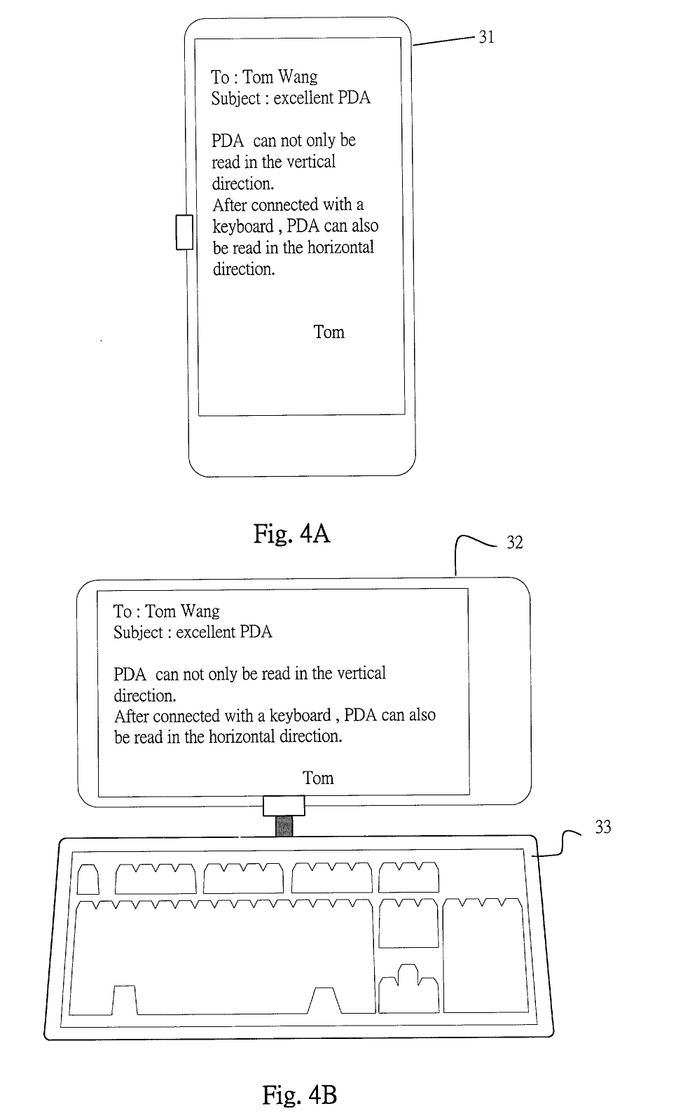

Please refer to FIG. 4A and FIG. 4B. FIG. 4A illustrates the PDA 41 and its display screen when the keyboard 43 is not connected thereto. FIG. 4B illustrates the PDA 41 and its display screen when the keyboard 43 is connected thereto. According to FIG. 4A and FIG. 4B, the convenience and result of the present invention should be demonstrated clearly.

It will be understood that certain features and sub-combinations are of utility and may be employed without reference to other features and sub-combinations as they are outlined within the claims. While the preferred embodiment and application of the invention has been described, it is apparent to those skilled in the art that the objects and features of the present invention are only limited as set forth in claims attached hereto.

What is claimed is:

1. An apparatus for displaying data, said apparatus comprising:
a display device;
a connecting device; and
a processing device, said processing device being electrically connected to said display device and said connecting device, as a peripheral device is detected as connecting to said connecting device, said processing device displays said data on said display device in a first direction, and as said peripheral device is detected as not connecting to said connecting device, said processing device displays said data on said display device in a second direction.

2. The apparatus as set forth in claim 1, wherein said first direction is perpendicular to said second direction.

3. The apparatus as set forth in claim 1, wherein said processing device is a handheld computer.

4. The apparatus as set forth in claim 3, wherein said handheld computer comprises a Personal Digital Assistant (PDA).

5. The apparatus as set forth in claim 1, wherein said connecting device is an interface of Universal Serial Bus (USB).

6. The apparatus as set forth in claim 1, wherein said peripheral device is an input device.

7. The apparatus as set forth in claim 6, wherein said input device comprises a keyboard.

8. A method for displaying data on a display device, the method comprising:
setting a status of a connecting device, and as said connecting device is connected to a peripheral device, said status is set as a first status, and as said connecting device is not connected to said peripheral device, said peripheral device is set as a second status; and
as a processing device detects said first status, said processing device displaying data on said display device in a first direction, as said processing device detects said second status, said processing device displaying data on said display device in a second direction.

9. The method as set forth in claim 8, wherein said first direction is perpendicular to said second direction.

10. The method as set forth in claim 8, wherein said processing device is a handheld computer.

11. The method as set forth in claim 10, wherein said handheld computer comprises a PDA.

12. The method as set forth in claim 8, said connecting device is an interface of USB.

13. The method as set forth in claim 8, said peripheral device is an input device.

14. The method as set forth in claim 13, said input device comprises a keyboard.

15. A display system being characterized in that:
as a peripheral device is detected, data is displayed in a first direction, and as said peripheral device is not detected, said data is displayed in a second direction.

16. The display system as set forth in claim 15, wherein said display system is a graphic output module of PDA.

17. The display system as set forth in claim 15, wherein said display system utilizes a status of a connecting device to detect the existence of said peripheral device.

18. The display system as set forth in claim 17, wherein said connecting device is an interface of USB.

19. The display system as set forth in claim 15, wherein said peripheral device is an input device.

20. The display system as set forth in claim 19, wherein said input device comprises a keyboard.
